(19) United States
(12) Patent Application Publication
(10) Pub. No.: US 2014/0355021 A1
(43) Pub. Date: Dec. 4, 2014

(54) IMAGE FORMING APPARATUS AND METHOD, AND NON-TRANSITORY COMPUTER READABLE MEDIUM

(71) Applicant: Fuji Xerox Co., Ltd., Tokyo (JP)

(72) Inventor: Kazuko KIRIHARA, Kanagawa (JP)

(73) Assignee: Fuji Xerox Co., Ltd., Tokyo (JP)

(21) Appl. No.: 14/103,088

(22) Filed: Dec. 11, 2013

(30) Foreign Application Priority Data
Jun. 4, 2013 (JP) 2013-117808

(51) Int. Cl. G06K 15/00

(52) U.S. Cl. CPC G06K 15/40
USPC 358/1.13

(57) ABSTRACT

An image forming apparatus includes a selector and an integrator. The selector selects plural pieces of setting unit information, each of the plural pieces of setting unit information including plural setting items. The integrator compares the associated plural setting items of the plural pieces of setting unit information selected by the selector, and integrates the plural pieces of setting unit information if the number of sets of associated setting items indicating different contents is equal to or smaller than a predetermined number.

### CROSS-REFERENCE TO RELATED APPLICATIONS

This application is based on and claims priority under 35 USC 119 from Japanese Patent Application No. 2013-117808 filed Jun. 4, 2013.

### BACKGROUND

### Technical Field

The present invention relates to an image forming apparatus and method, and a non-transitory computer readable medium.

### SUMMARY

According to an aspect of the invention, there is provided an image forming apparatus including a selector and an integrator. The selector selects plural pieces of setting unit information, each of the plural pieces of setting unit information including plural setting items. The integrator compares the associated plural setting items of the plural pieces of setting unit information selected by the selector, and integrates the plural pieces of setting unit information if the number of sets of associated setting items indicating different contents is equal to or smaller than a predetermined number.

### BRIEF DESCRIPTION OF THE DRAWINGS

An exemplary embodiment of the present invention will be described in detail based on the following figures, wherein:

FIG. 1 is a block diagram illustrating an example of the configuration of an image forming apparatus according to an exemplary embodiment;

FIG. 2 schematically illustrates an example of the configuration of setting information;

FIGS. 3A and 3B schematically illustrate an example of a setting information integrating operation performed by the image forming apparatus of this exemplary embodiment;

FIG. 4 schematically illustrates another example of the setting information integrating operation performed by the image forming apparatus of this exemplary embodiment;

FIG. 5 schematically illustrates an example of the configuration of integrated setting information according to this exemplary embodiment;

FIGS. 6A and 6B schematically illustrate another example of the setting information integrating operation performed by the image forming apparatus of this exemplary embodiment;

FIG. 7 schematically illustrates another example of the setting information integrating operation performed by the image forming apparatus of this exemplary embodiment;

FIG. 8 schematically illustrates another example of the setting information integrating operation performed by the image forming apparatus of this exemplary embodiment;

FIG. 9 schematically illustrates an example of a setting information calling operation performed by the image forming apparatus of this exemplary embodiment;

FIG. 10 schematically illustrates another example of the setting information calling operation performed by the image forming apparatus of this exemplary embodiment; and

FIG. 11 is a flowchart illustrating an example of the setting information integrating operation performed by the image forming apparatus of this exemplary embodiment.

### DETAILED DESCRIPTION

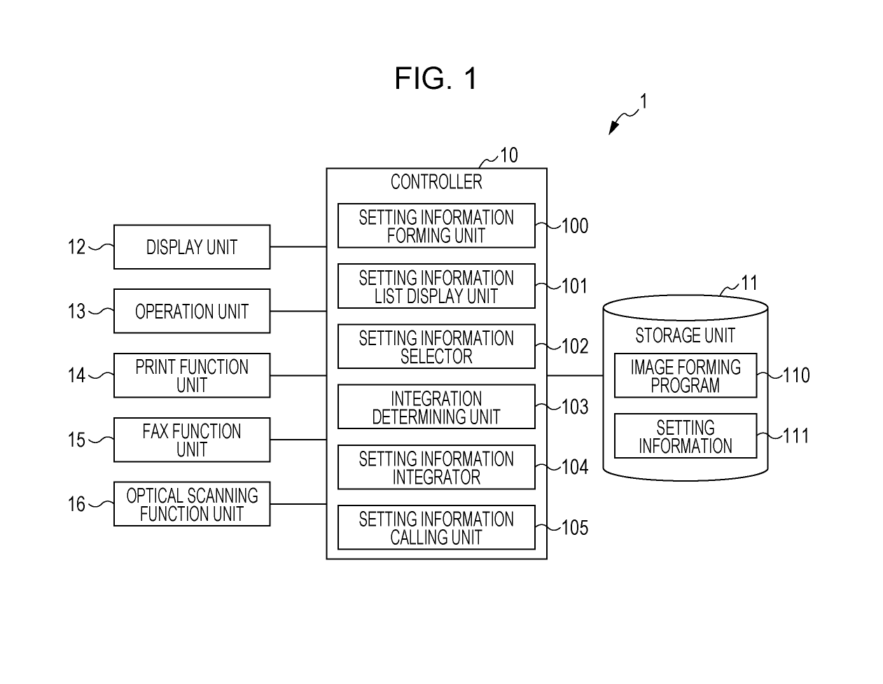

FIG. 1 is a block diagram illustrating an example of the configuration of an image forming apparatus 1 according to an exemplary embodiment.

The image forming apparatus 1, which is a multifunction device having print, copy, scanner, and facsimile (FAX) functions, includes a controller 10 which is constituted by a central processing unit (CPU) and other elements, and controls individual components and executes various programs, a storage unit 11 which is constituted by a storage medium, such as a flash memory, and stores information therein, a display unit 12 which displays characters, images, and so on, an operation unit 13 which is used for operating the image forming apparatus 1, a print function unit 14 which performs printing on paper, a FAX function unit 15 which sends and receives information according to FAX standards, and an optical scanning function unit 16 which optically scans a paper document and generates image information.

The controller 10 executes an image forming program 110, which will be discussed later, and thereby functions as a setting information forming unit 100, a setting information list display unit 101, a setting information selector 102, an integration determining unit 103, a setting information integrator 104, and a setting information calling unit 105.

The setting information forming unit 100 forms, as a preset, setting unit information indicating a combination of plural setting items for the print function unit 14, the FAX function unit 15, and the optical scanning function unit 16. The setting information forming unit 100 registers the formed setting unit information in setting information 111 stored in the storage unit 11. That is, the setting information 111 includes single or plural pieces of setting unit information.

The setting information list display unit 101 displays a list of single or plural pieces of setting unit information included in the setting information 11 on the display unit 12 by using icons.

From among icons displayed on the display unit 12 by the setting information list display unit 101, the setting information selector 102 selects at least two icons that a user wishes to integrate in accordance with the content of an operation performed on the operation unit 13 by the user.

The integration determining unit 103 determines whether or not the pieces of setting unit information associated with the icons selected by the setting information selector 102 can be integrated with each other.

The setting information integrator 104 integrates setting items included in the pieces of setting unit information which are determined to be integrated by the integration determining unit 103 so as to generate a new piece of setting unit information.

The setting information calling unit 105 selects an icon displayed on the display unit 12 by the setting information list display unit 101 in accordance with the content of an operation performed on the operation unit 13 by the user, and thereby calls a piece of setting unit information associated with the selected icon.

The storage unit 11 stores therein the image forming program 110 which causes the controller 10 to operate as the setting information forming unit 100, the setting information list display unit 101, the setting information selector 102, the integration determining unit 103, the setting information integrator 104, and the setting information calling unit 105. The storage unit 11 also stores therein the setting information 111.

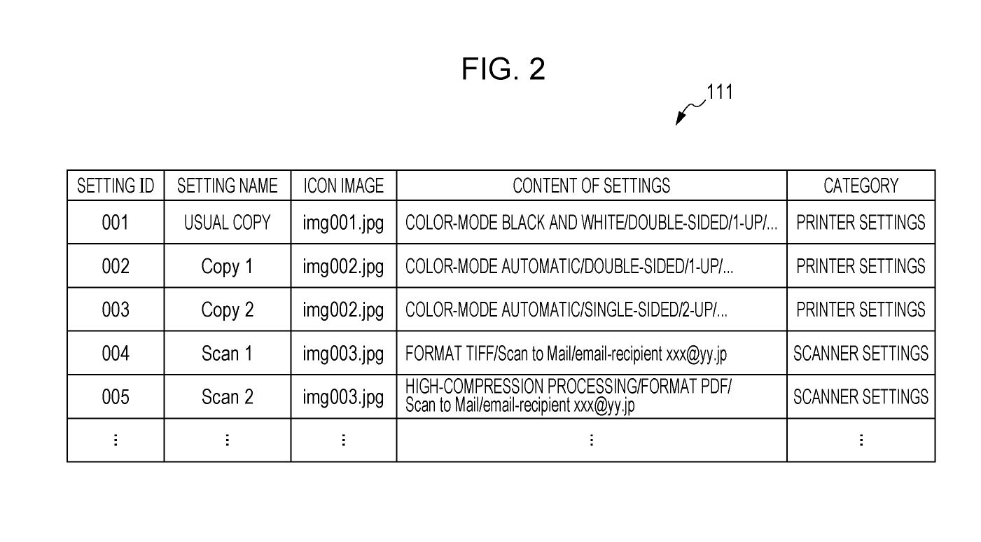

FIG. 2 schematically illustrates an example of the configuration of the setting information 111 according to this exemplary embodiment.

The setting information 111 includes items of information concerning each piece of setting unit information, such as a setting ID, which is an ID for identifying each piece of setting unit information, a setting name of a name appended to each piece of setting unit information, an icon image used for displaying each piece of setting unit information as a list, the content of settings indicating the content of each piece of setting unit information, and a category indicating a category of a setting of each piece of setting unit information.

(Operation of Image Forming Apparatus)

Operations of this exemplary embodiment will be described below through (1) a preregistering operation, (2) a setting information integrating operation, and (3) a setting information calling operation.

(1) Preregistering Operation

A user of the image forming apparatus 1 first registers setting unit information by way of an operation performed on the operation unit 13 of the image forming apparatus 1 or by accessing the image forming apparatus 1 from an external device.

The user determines, as shown in FIG. 2, a setting ID, a setting name, an icon image, the content of settings, and a category, as the registration contents of setting unit information.

The setting information forming unit 100 receives setting items of the determined piece of setting unit information, and registers the setting items in the setting information 111 stored in the storage unit 11.

(2) Setting Information Integrating Operation

The user first operates the operation unit 13 and makes a request to display a list of pieces of setting unit information included in the setting information 111.

In response to this request, the setting information list display unit 101 displays a list of pieces of setting unit information included in the setting information 111 by using icons.

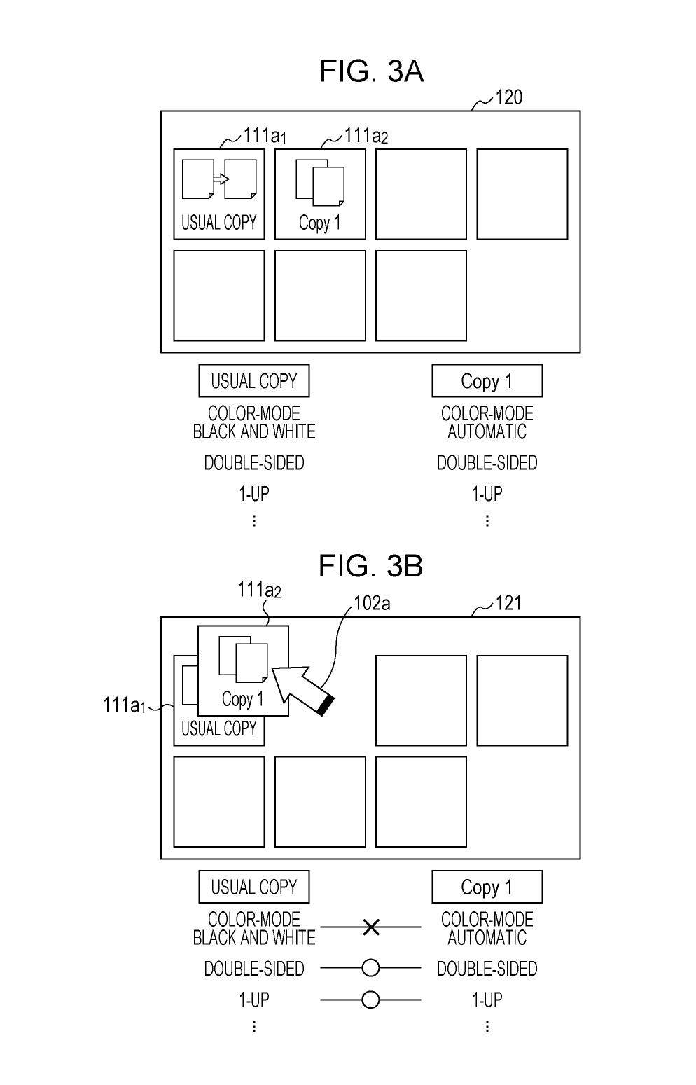

FIGS. 3A and 3B schematically illustrate an example of a setting information integrating operation performed by the image forming apparatus 1 of this exemplary embodiment.

On a screen 120 shown in FIG. 3A, pieces of setting unit information included in the setting information 111 are displayed as icons 111a₁ and 111a₂ in the form of a list.

As shown in FIG. 3B, by operating the operation unit 13, a user selects the icons 111a₁ and 111a₂ with a cursor 102a on a screen 121 and superposes the icons 111a₁ and 111a₂ on each other.

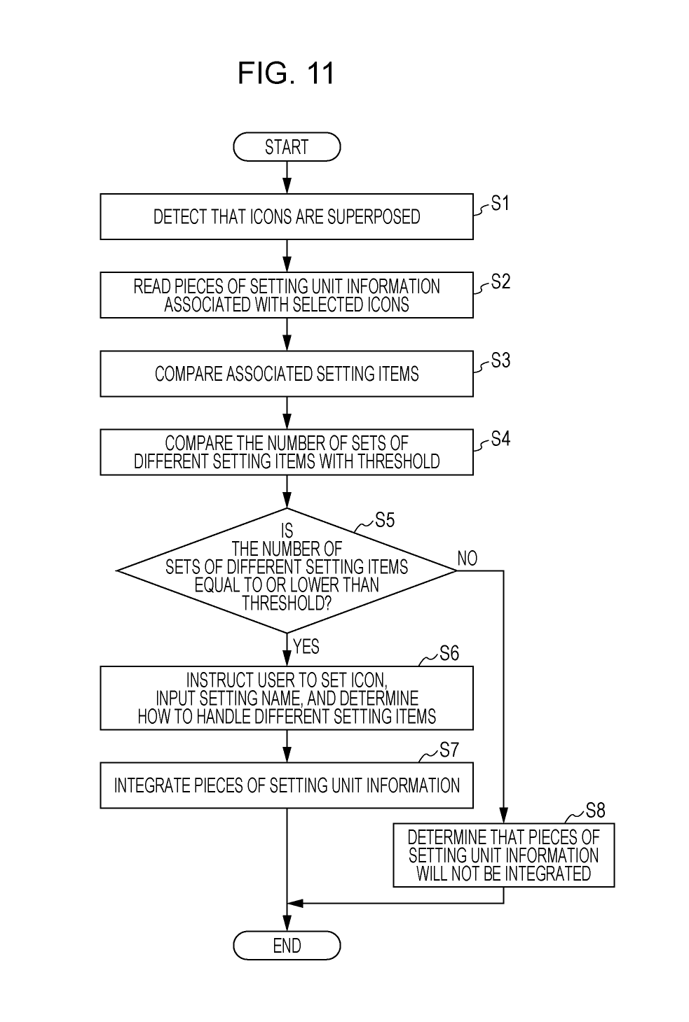

FIG. 11 is a flowchart illustrating an example of the setting information integrating operation performed by the image forming apparatus 1 of this exemplary embodiment.

In step S1, the setting information selector 102 detects that the icons 111a₁ and 111a₂ are superposed on each other by way of an operation of the user. Then, in step S102, the setting information selector 102 selects pieces of setting unit information associated with the icons 111a₁ and 111a₂ selected by the user and reads the contents of the selected pieces of setting unit information.

In this case, it is assumed by way of example that the pieces of setting unit information having setting IDs “001” and “002” shown in FIG. 2A have been selected. The contents of settings of these pieces of setting unit information are those shown in FIG. 3A.

Then, in step S3, the integration determining unit 103 compares the associated setting items of the pieces of setting unit information, as shown in FIG. 3B. In the example shown in FIG. 3B, “color-mode black and white” and “color-mode automatic” are different setting items, and “double-sided”, “1-up”, and other items are common setting items.

Accordingly, the integration determining unit 103 identifies that the number of sets of different setting items of the pieces of setting unit information having the setting IDs “001 and “002” is “one”. Then, in step S4, the integration determining unit 103 compares the number of sets of different setting items with a threshold, which is “one”. In step S5, the integration determining unit 103 determines whether the number of sets of different setting items is equal to or lower than the threshold. In this case, since the result of step S5 is YES, the process proceeds to step S6. In step S6, a screen for instructing the user to set an icon, to input a setting name, and to determine how to handle different setting items of the integrated pieces of setting unit information is displayed.

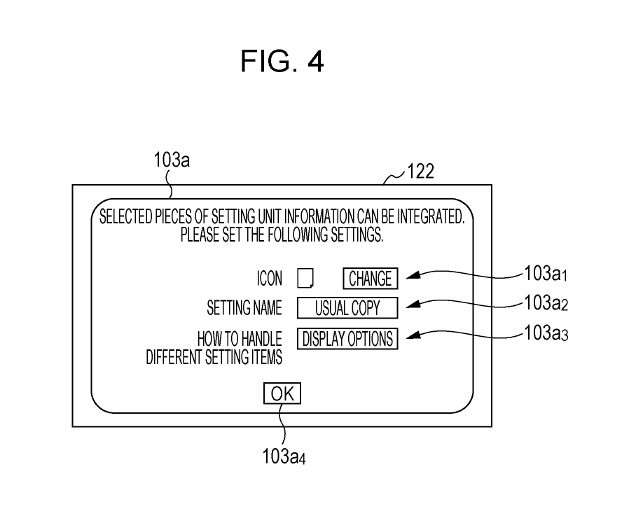

FIG. 4 schematically illustrates another example of the setting information integrating operation performed by the image forming apparatus 1 of this exemplary embodiment.

On a screen 122 shown in FIG. 4, a screen frame 103a for instructing the user to set an icon, to input a setting name, and to determine how to handle different setting items of integrated pieces of setting unit information is displayed. The screen frame 103a includes a button 103a₁ for allowing the user to change the icon, a box 103a₂ for allowing the user to input a setting name, a menu 103a₃ for displaying options for instructing the user to determine how to handle different setting items, and a button 103a₄ for setting the icon, the setting name, and the option selected by the user by using the button 103a₁, the column 103a₂, and the menu 103a₃, respectively.

The user operates the button 103a₁ so as to change the icon, input a setting name “usual copy” into the box 103a₂, and select “select one of setting items of pieces of setting unit information which have not been integrated” from among the options displayed in the menu 103a₃ as a way of handling different setting items.

In step S7, the setting information integrator 104 integrates the pieces of setting unit information having the setting IDs “001” and “002” into a piece of setting unit information having an ID “006”. That is, the setting information integrator 104 deletes the pieces of setting unit information having the setting IDs “001” and “002” and creates a new piece of setting unit information having the setting ID “006”.

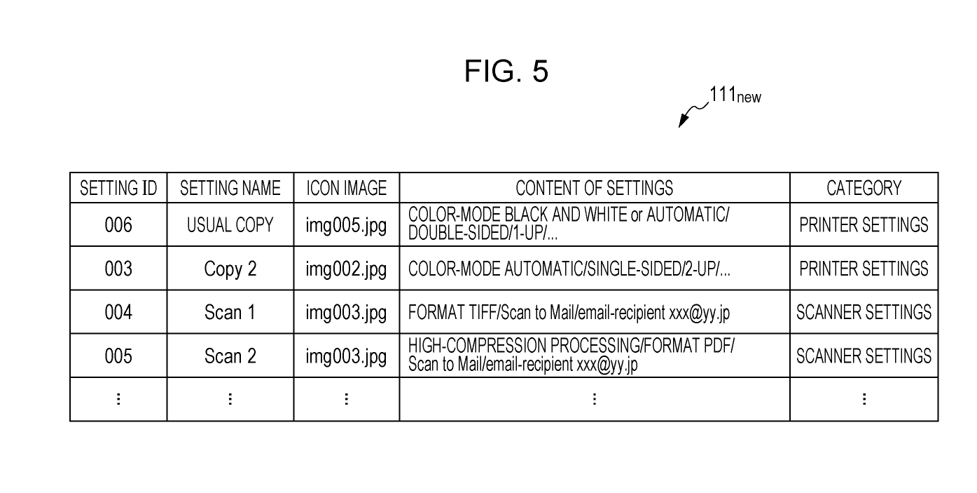

FIG. 5 schematically illustrates an example of the configuration of setting information obtained by integrating pieces of setting unit information according to this exemplary embodiment.

Setting information 111_{new} is information from which the pieces of setting unit information having the setting IDs “001” and “002” are deleted from the setting information 111 shown in FIG. 2 and to which a new piece of setting unit information having the setting ID “006” obtained by integrating the pieces of setting unit information having the setting IDs “001” and “002” is added.

As another example, a case in which pieces of setting unit information are not integrated will be described below.

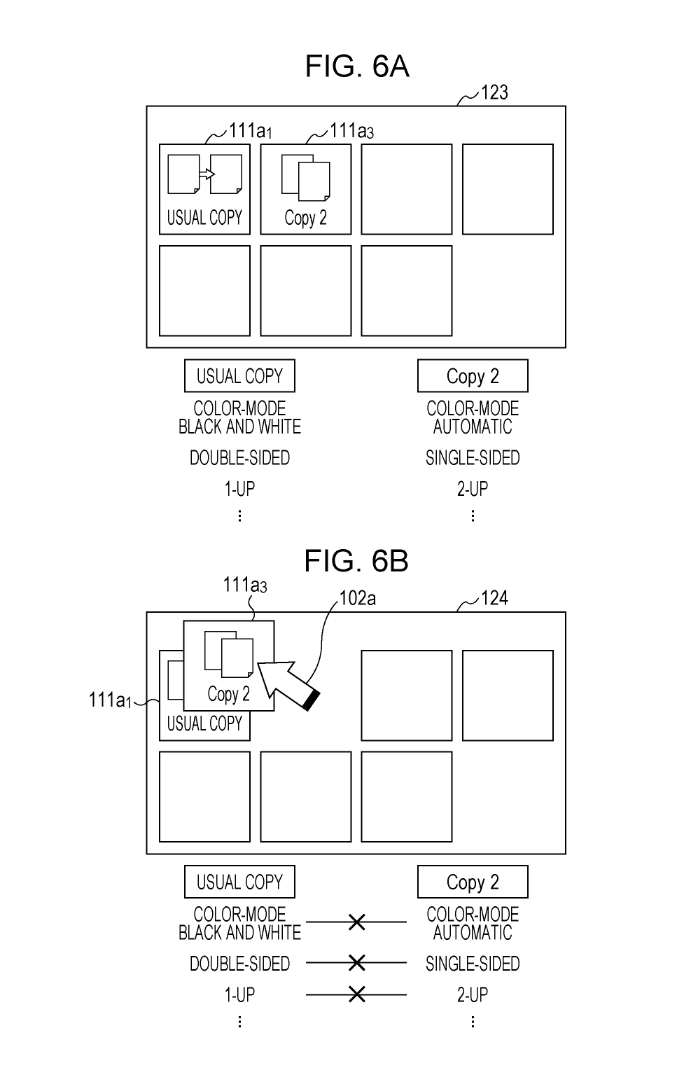

FIGS. 6A and 6B schematically illustrate another example of the setting information integrating operation performed by the image forming apparatus 1 of this exemplary embodiment.

On a screen 123 shown in FIG. 6A, pieces of setting unit information included in the setting information 111 are displayed as icons 111a₁ and 111a₃ in the form of a list.

As shown in FIG. 6B, by operating the operation unit 13, the user selects the icons 111a₁ and 111a₃ with the cursor 102a on a screen 124 and superposes the icons 111a₁ and 111a₃ on each other.

In this case, it is assumed by way of example that pieces of setting unit information having setting IDs “001” and “003” shown in FIG. 2A have been selected. The contents of settings of these pieces of setting unit information are those shown in FIG. 6A.

Then, in step S3, the integration determining unit 103 compares the associated setting items of the pieces of setting unit information, as shown in FIG. 6B. In the example shown in FIG. 6B, the associated setting items, such as “color-mode black and white” and “color-mode automatic”, “double-sided” and “single-sided”, and “1-up” and “2-up”, are all different.

Accordingly, the integration determining unit 103 identifies that the number of sets of different setting items of the pieces of setting unit information having the setting IDs “001” and “003” is “three”. Then, in step S4, the integration determining unit 103 compares the number of sets of different setting items with a threshold, which is “one”. In step S5, the integration determining unit 103 determines whether the number of sets of different setting items is equal to or lower than the threshold, and in this case, since the result of step S5 is NO, the process proceeds to step S8. In step S8, the integration determining unit 103 determines that the pieces of setting unit information will not be integrated. In this case, the integration determining unit 103 displays information indicating that the pieces of setting unit information will not be integrated on a screen 125 in the following manner.

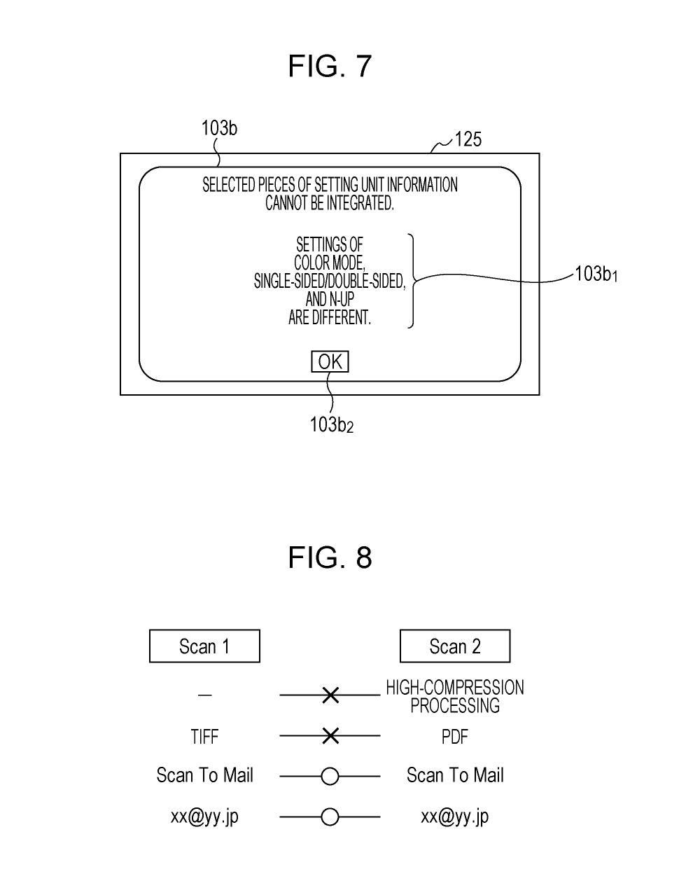

FIG. 7 schematically illustrates another example of the setting information integrating operation performed by the image forming apparatus 1 of this exemplary embodiment.

On the screen 125 shown in FIG. 7, a screen frame 103b indicating information that integration will not be performed is displayed. The screen frame 103b includes a description 103b₁ showing reasons why integration will not be performed and a button 103b₂ for allowing the user to accept the reasons provided in the description 103b₁ and closing the screen frame 103b.

As stated above, when the threshold is “one”, if the number of sets of different setting items of pieces of setting unit information is “two” or more, these pieces of setting unit information are not integrated. However, if there is a correlation between certain setting items as described below, the manner of counting sets of different setting items is changed.

FIG. 8 schematically illustrates another example of the setting information integrating operation performed by the image forming apparatus 1 of this exemplary embodiment.

In the example shown in FIG. 8, it is assumed by way of example that pieces of setting unit information having setting IDs “004” and “005” shown in FIG. 2 have been selected. The contents of settings of these pieces of setting unit information are those shown in FIG. 8.

Then, the integration determining unit 103 compares the associated setting items of the pieces of setting unit information, and determines that the associated setting items, such as “- (no setting)” and “high-compression processing”, and “TIFF” and “PDF”, are different.

In this case, the integration determining unit 103 would normally determine that the number of sets of different setting items of the pieces of setting unit information having the setting IDs “004” and “005” is “two”. However, if specifications are such that it is not possible to specify for the file format “TIFF” whether or not high-compression processing will be performed, the integration determining unit 103 determines that there is a correlation between the file format and the high-compression processing and determines that the number of sets of different setting items is “one”. That is, the integration determining unit 103 determines that these pieces of setting unit information will be integrated.

The calling operation of integrated setting unit information will now be described below.

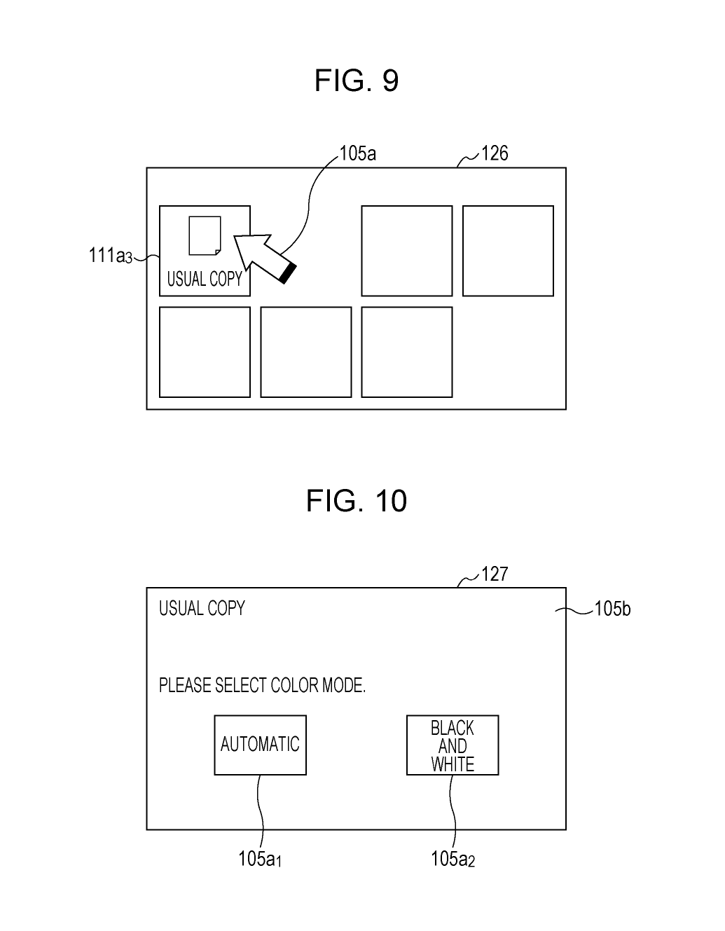

(3) Setting Information Calling Operation FIG. 9 schematically illustrates an example of the setting information calling operation performed by the image forming apparatus 1 of this exemplary embodiment.

On a screen 126 shown in FIG. 9, the setting unit information having the setting ID “006” included in the setting information 111_{new} is displayed as the icon 111a₃ in part of a list.

As shown in FIG. 9, by operating the operation unit 13, the user selects the icon 111a₃ with a cursor 105a on the screen 126 so as to make a request to call the content of setting unit information.

Upon detecting that the icon 111a₃ has been selected by way of the operation of the user, the setting information calling unit 105 calls the setting unit information having the setting ID “006” from the setting information 111_{new}. If the contents of settings include “or”, the setting information calling unit 105 identifies that “select one of setting items of pieces of setting unit information which have not been integrated” has been selected as a way of handling different setting items, and then displays the setting items of pieces of setting unit information which have not been integrated, that is, “color-mode automatic” and “color-mode black and white”, and causes the user to select one of the setting items.

FIG. 10 schematically illustrates another example of the setting information calling operation performed by the image forming apparatus 1 of this exemplary embodiment.

On a screen 127 shown in FIG. 10, a screen frame 105b for causing the user to select one of setting items of pieces of setting unit information which have not been integrated is displayed, and the screen frame 105b includes a button 105a₁ for selecting a setting item “color-mode automatic” and a button 105a₂ for selecting a setting item “color-mode black and white”.

The user selects one of the buttons 105a₁ and 105a₂, and the setting information calling unit 105 executes the subsequent processing by using the setting item associated with the selected button.

### Other Exemplary Embodiments

The present invention is not restricted to the above-described exemplary embodiment, and various modifications may be made without departing from the spirit of the invention. For example, in the above-described exemplary embodiment, in response to the selection of icons by a user, pieces of setting unit information associated with the selected icons are integrated. However, a search may be automatically conducted for pieces of setting unit information having a smaller number of sets of associated different setting items, and the searched pieces of setting unit information may be integrated.

In the above-described exemplary embodiment, functions of the setting information forming unit 100, the setting information list display unit 101, the setting information selector 102, the integration determining unit 103, the setting information integrator 104, and the setting information calling unit 105 of the controller 10 are implemented by a program. However, all of or some of the above-described elements may be implemented by hardware, such as an application specific integrated circuit (ASIC). Alternatively, the program used in the above-described exemplary embodiment may be recorded on a recording medium, such as a compact-disc read only memory (CD-ROM), and may be provided. The steps discussed in the above-described exemplary embodiment may be exchanged, deleted, or added without departing from the spirit of the invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a selector configured to select a plurality of pieces of setting unit information, each of the plurality of pieces of setting unit information including a plurality of setting items; and
an integrator configured to compare the plurality of associated setting items of the plurality of pieces of setting unit information selected by the selector, and integrate the plurality of pieces of setting unit information if the number of sets of associated setting items indicating different contents is equal to or smaller than a predetermined number.

2. The image forming apparatus according to claim 1, wherein, concerning a set of associated setting items indicating different contents, the integrator determines a selected one of values of the associated setting items of the selected pieces of setting unit information which have not been integrated as a value of an integrated setting item.

3. The image forming apparatus according to claim 2, further comprising:
a calling unit configured to call a piece of setting unit information,
wherein, if the piece of setting unit information called by the calling unit is a piece of integrated setting unit information including associated setting items having different contents, the integrator performs an integrating operation such that one of values of the associated setting items of the pieces of setting unit information which have not been integrated is selectable.

4. An image forming method comprising:
selecting a plurality of pieces of setting unit information, each of the plurality of pieces of setting unit information including a plurality of setting items; and
comparing the plurality of associated setting items of the plurality of selected pieces of setting unit information and integrating the plurality of pieces of setting unit information if the number of sets of associated setting items indicating different contents is equal to or smaller than a predetermined number.

5. A non-transitory computer readable medium storing a program causing a computer to execute a process, the process comprising:
selecting a plurality of pieces of setting unit information, each of the plurality of pieces of setting unit information including a plurality of setting items; and
comparing the plurality of associated setting items of the plurality of selected pieces of setting unit information and integrating the plurality of pieces of setting unit information if the number of sets of associated setting items indicating different contents is equal to or smaller than a predetermined number.
